(19) United States
(12) Patent Application Publication
(10) Pub. No.: US 2015/0199082 A1
(43) Pub. Date: Jul. 16, 2015

(54) DISPLAYING ACTIONABLE ITEMS IN AN OVERSCROLL AREA

(71) Applicant: Google Inc., Mountain View, CA (US)

(72) Inventors: Jerome F. SCHOLLER, San Francisco, CA (US); Jesse Ryan GREENWALD, San Mateo, CA (US)

(73) Assignee: Google Inc., Mountain View, CA (US)

(21) Appl. No.: 13/675,838

(22) Filed: Nov. 13, 2012

(51) Int. Cl. G06F 3/0482; G06F 3/0488; G06F 3/0485

(52) U.S. Cl. CPC G06F 3/0482; G06F 3/0485; G06F 3/0488

(57) ABSTRACT

Systems and methods for user interface management are provided. In some aspects, a first scroll beyond an original content being presented for a user is detected, where the first scroll indicates an overscroll event. Menu content is provided for display upon detection of the first scroll, where the menu content includes one or more actionable items.

### BACKGROUND

The subject technology generally relates to user interfaces and, in particular, relates to displaying action items in an overscroll area.

Accessing menu items and settings, particularly for touch input based software on an electronic device (e.g., a mobile phone or tablet computer), can be cumbersome. Accessing menu items can involve tapping on a button that shows a menu dialog. When a user is scrolling through content by swiping across the screen, tapping on a very specific area to show the menu may not be a natural action. Furthermore, performing an action often requires at least two taps, one tap to show the menu, and a second tap to select the action to perform.

### SUMMARY

In some aspects, the disclosed subject matter relates to a computer-implemented method for user-interface management. The method includes detecting a first scroll beyond an original content being presented for a user, where the first scroll indicates an overscroll event. The method includes providing for display of menu content upon detection of the first scroll, where the menu content includes one or more actionable items.

In some aspects, the disclosed subject matter relates to a computer-readable medium encoded with executable instructions for user interface management. The instructions include code for providing for display of first content via a touch screen, where the first content has a termination point in a first axis. The instructions include code for receiving, via the touch screen, an indication of first scroll of the first content along the first axis, where the first scroll extends beyond the termination point of the first content. The instructions include code for providing for display, in response to the received indication of the first scroll, of a region via the touch screen, where the region does not include the first content. The instructions include code for providing for display, within the region, of one or more user interface icons for entering commands.

In some aspects, the disclosed subject matter relates to a system. The system includes one or more processors and a memory. The memory includes instructions for user interface management. The instructions include code for providing for display of first content via a touch screen, where the first content has a termination point in a first axis. The instructions include code for receiving, via the touch screen, an indication of first scroll of the first content along the first axis, where the first scroll extends beyond the termination point of the first content. The instructions include code for providing for display, in response to the received indication of the first scroll, of a region via the touch screen, where the region does not include the first content. The instructions include code for providing for display, within the region, of one or more user interface icons, the one or more user interface icons being partially displayed. The instructions include code for receiving, via the touch screen, an indication of further scrolling in a direction of the first scroll. The instructions include code for increasing, in response to the received indication of the further scrolling, a size of the region to fully display the one or more user interface icons.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIGS. 1A-1C illustrate example user interfaces of mobile devices that display actionable items in an overscroll area.

FIG. 2 illustrates an example computing device configured to display actionable items in an overscroll area.

FIG. 3 illustrates an example process for displaying user interface icons in response to scrolling.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject disclosure extends scrollable content with menu items content. The menu items content may include a list of actionable items or icons for user selection. In various aspects, when a user scrolls past the content, of a particular page or frame or user interface, being scrolled, an overscroll area is exposed, containing menu items content. The menu items content includes a list of actionable items for user action. The actionable items may be presented based on the context (e.g., the scrollable content for which the menu content is being extended) from which the overscroll event is detected.

For example, where content being scrolled is a webpage in a web browser, the menu items presented in the overscroll area may include the following actionable items: “a new page”, “reload page”, “print”, “back”, “close page”, “settings”, “exit browser”, or other web browser related functions. As another example, where the content being scrolled is a list of electronic messages (e.g., emails) in an electronic messaging program, the actionable items may include actions such as “next message”, “refresh messages”, “compose new message”, “delete”, “move message”, and other email related functionality. In various aspects, actionable items presented in the overscroll area may be global actions, unrelated to the context (e.g., unrelated to the content being scrolled) from which the overscroll event is detected. For example, the overscroll area in a web browser or electronic messaging program may include an actionable item to open a telephone directory or initiate a telephone call or to provide the main/home page for a computing device.

Menu items content may be displayed in an overscroll area upon a user scrolling beyond the content of a frame or page the user is scrolling, an extended scroll. For example, an overscroll event may be based on scrolling beyond scrollable content by a certain amount. An overscroll event may also be based on scrolling beyond the content for a certain amount of time. Any other type of events that indicate an overscroll (e.g., an overscroll event entered via a mouse, a keypad, or a voice interface) may be used to invoke the display of menu items content in the overscroll space.

In some aspects, upon a user scrolling past the content of the page or frame or user interface being presented for the user, menu items available for the overscroll area may be partially exposed. Partially exposing the menu items may occur for example, where a full overscroll event has not been detected (e.g., when the amount or time of overscrolling does not amount to an overscroll event). As such, scrolling past the content, but not so much past the content that it amounts to an overscroll event, may lead to partially exposing a “drawer” of menu items available for display in the overscroll area. Partially exposed menu items content may then be fully exposed (e.g., a drawer of menu items “pops” open exposing all the items in the drawer) upon a user further scrolling or pulling on the content even further. To close an “open” drawer of menu items, a user may scroll in the opposite direction of the direction that led to the menu items content being uncovered.

The content and the menu items may be displayed simultaneously (e.g., while the user is scrolling). In some aspects, after the user finishes scrolling and releases the input object (e.g., a finger, a stylus, or any other input devices) from the touch screen, the content springs back to cover the menu items. Alternatively, the user may move the input object roughly orthogonally (e.g., between 75 and 105 degrees) to the scrolling direction (e.g., to the left or to the right if the user was scrolling downward) to indicate that he/she desires for the menu items to remain visible and for the content to not spring back. In other aspects, after the user releases the input object, the menu items remain open adjacent to the content until the user scrolls the content to cover the menu items or closes the associated application. In some aspects, the “open” drawer of menu items is closed or the menu items are no longer displayed on the user's device upon selection of one of the items in the menu items.

The menu items content may be exposed in any direction of scrolling (e.g., up, down, right, or left) where the content has a termination point. For example, a user scrolling content upwards may cause menu items to be displayed at the bottom and vice versa for a user scrolling content downwards. Menu items may also be displayed on the right or left side of a page or frame being scrolled, thus exposing an overscroll area on the right or left side. The direction of the scrolling can be in either direction and the overscroll area exposed can be used to display menu items content. The menu items may be different or the same based on the direction of the overscroll area that is exposed.

The display of menu items in an overscroll area may be user or system defined. The types of actionable items and the style, format, size, etc. of the displayed items may also be either user or system configurable.

Content displayed or presented to a user (e.g., as scrollable content) may be local content or may be received from a server for display at a client computing device. User interfaces (e.g., a page or frame) that present the scrollable content may be provided locally (e.g. by the client computing device on which the content is presented) or from a server. The actions provided as menu content may be local actions or remote actions (e.g., for a server to handle).

The displaying of menu items content in an overscroll area, as provided for by the subject technology, may be used with touch devices or with pointing devices such as a mouse. However, the subject technology is not limited to touch or pointing devices, and can be used for any device or functionality that allows scrolling, particularly scrolling beyond displayed content.

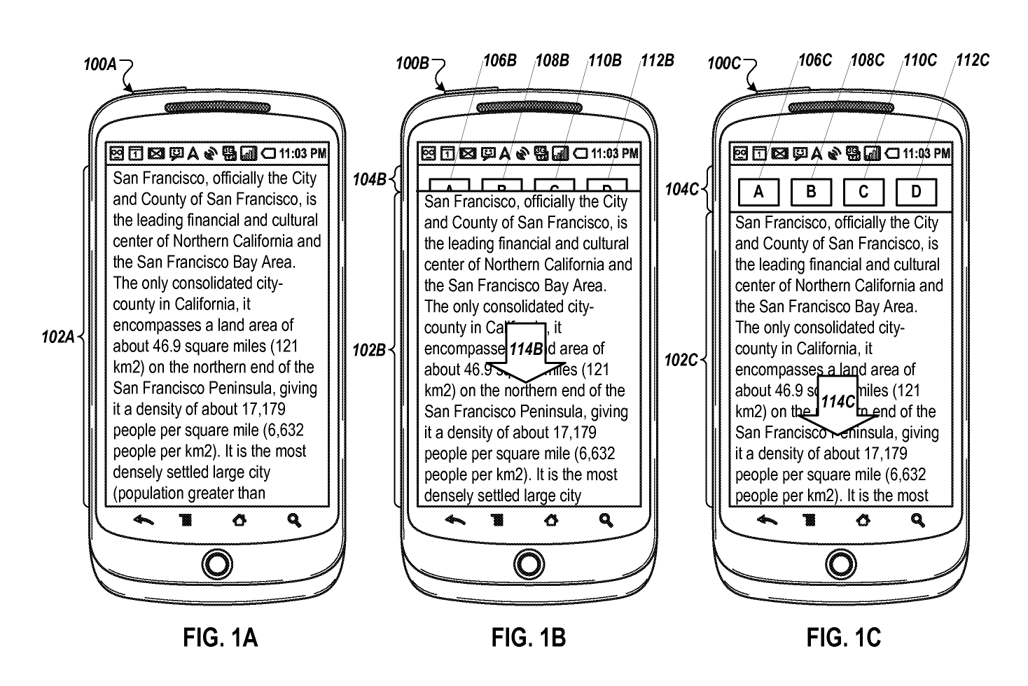

FIGS. 1A-1C illustrate example user interfaces of mobile devices 100A, 100B, and 100C that display actionable items in an overscroll area. The mobile devices 100A, 100B, and 100C correspond to the same mobile device at different points in time.

Mobile device 100A, as shown in FIG. 1A, includes content 102A on its screen. As shown, the content 102A is text, which may be displayed via a web browser, an electronic messaging (e.g., email or text messaging) application, a newspaper application, an encyclopedia application, etc. In some aspects, the content 102A may also include image(s) or video(s). As shown, the content 102A starts with the word “San Francisco,” and has no additional data above the word “San Francisco.” Therefore, the content cannot be scrolled to view content above the word “San Francisco.” In other words, the content cannot be scrolled downward. As used herein, the phrase “scrolling downward” may refer to moving the content downward to display additional material at the top of the screen. Scrolling downward may be achieved, for example, by moving a finger downward on a touch screen. The phrases “scrolling upward,” scrolling leftward,” and “scrolling rightward” may have parallel meanings.

To reach the interface of mobile device 100B, as shown in FIG. 1B, a user of mobile device 100A may scroll downward, as indicated by arrow 114B, the content 102A of the mobile device 100A, leading to content 102B of the mobile device 102B. Arrow 114B may correspond to a movement of an input object (e.g., a finger or a stylus). As shown, the content 102B is similar to the content 102A, but missing the bottom line (which includes the text “population greater than”).

As a result of the scrolling downward of the content 102B beyond the termination point (above the word “San Francisco”) of the content 102B, region 104B appears above the content 102B. As shown, the region 102B includes partially displayed user interface icons 106B, 108B, 110B, and 112B (which are fully displayed in FIG. 1C). The user interface icons 106B, 108B, 110B, and 112B may be buttons for entering commands. For example, in a web browser application, the user interface icons 106B, 108B, 110B, and 112B may correspond to a back button, a forward button, a reload page button, a new tab button, a close tab button, etc.

The interface of the mobile device 100B may be further scrolled down, to reach the interface of the mobile device 100C, as shown in FIG. 1C. The scrolling is indicated via arrow 100C, which may correspond to a movement of an input object. In the mobile device 100C, the content 102C is similar to the content 102B, but is further scrolled downward and has the last line of the content 102B (“densely settled large city”) removed. Region 104C is slightly larger than region 104B, due to the content 102C being scrolled further downward to expose more space, allowing the user interface icons 106C, 108C, 110C, and 112C to be fully exposed for the user to be able to view or select the user interface icons 106C, 108C, 110C, and 112C. In some aspects, the user may use a second input object (e.g., a second finger or stylus) to select one of the user interface icons 106C, 108C, 110C, or 112C, while using the input object for scrolling according to arrow 114C to prevent the content 102C from snapping back to the position of the content 102A. In some aspects, the content 102C may automatically remain in the position of the content 102C, allowing the region 104C to be exposed, until the user scrolls the content 102C upward to cover the region 104C. When the user scrolls the content 102C upward, the display of the mobile device 100C may return to the display of the mobile device 100B, if the user continues scrolling upward, the display may return to the display of mobile device 100A. In some aspects, the content 102C may snap back to the position of the content 102A unless the user indicates that he/she does not desire for the content 102C to snap back to position of the content 102A. The user may indicate that he/she does not desire for the content 102C to snap back, for example, by moving the input object roughly orthogonally (e.g., between 75 and 105 degrees) to the direction of the scrolling. As shown, the scrolling 114C is downward. Thus, the user may move the input object to the left or to the right to indicate that he/she does not desire for the content 102C to snap back.

In some aspects, the user may select one of the user interface icons 106C, 108C, 110C, or 112C by touching the desired icon 106C, 108C, 110C, or 112C. In response, an application may enter a command or take an action corresponding to the selected user interface icon 106C, 108C, 110C, or 112C. In some aspects, the user may select one of the user interface icons 106C, 108C, 110C, or 112C by scrolling orthogonally to the direction of the drawer (of menu items), while maintaining contact of the input object on the device's screen. A selected item may be visually marked as selected, and moving orthogonally may change the selection of the item. Releasing the input object, e.g., lifting the input object off the device's screen, while an action item is selected may perform the action embodied by the item.

The user interface icons 106C, 108C, 110C, and 112C are pictured as having the characters “A,” “B,” “C,” and “D,” respectively, but may include other graphical objects. For example, a user interface icon corresponding to a back or previous command may include a left arrow. A user interface icon corresponding to a print command can include a picture of a printer. Also, while four user interface icons 106C, 108C, 110C, and 112C, the subject technology may be implemented with any number of user interface icons (e.g., one, two, three, four, five, or more than five icons).

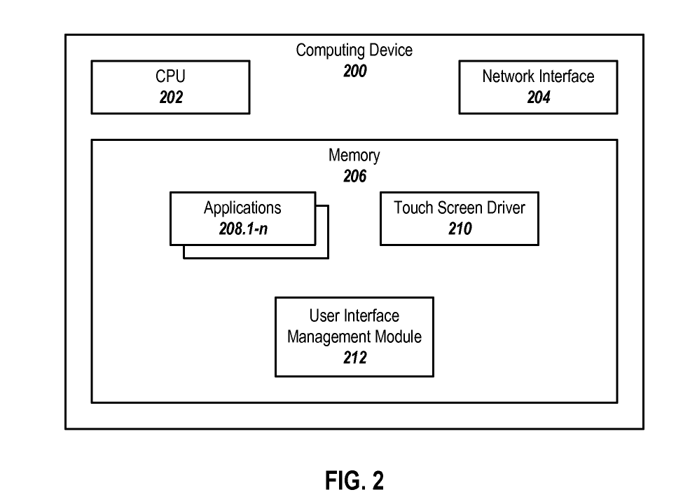

FIG. 2 illustrates an example computing device 200 configured to display actionable items in an overscroll area. The computing device 200 can correspond to the mobile device(s) 100A, 100B, or 100C. The computing device 200 may be a laptop computer, a desktop computer, a mobile phone, a personal digital assistant (PDA), a tablet computer, a netbook, a television with one or more processors embedded therein or coupled thereto, a physical machine, or a virtual machine. The computing device 200 may include input/output devices, for example, one or more of a keyboard, a mouse, a display, or a touch screen.

As shown, the computing device 200 includes a central processing unit (CPU) 202, a network interface 204, and a memory 206. The CPU 202 may include one or more processors. The CPU 202 is configured to execute computer instructions that are stored in a computer-readable medium, for example, the memory 206. The network interface 204 is configured to allow the data repository 110 to transmit and receive data in a network, e.g., the Internet, a cellular network, or a WiFi network. The network interface 204 may include one or more network interface cards (NICs). The memory 206 stores data or instructions. The memory 206 may be one or more of a cache unit, a storage unit, an internal memory unit, or an external memory unit. As illustrated, the memory 206 includes applications 208.1-n, a touch screen driver 210, and a user interface management module 212.

The applications 208.1-n may include any applications executing on the computing device 200. The applications 208.1-n may include, for example, a web browser application, an electronic messaging application, a word processing application, an encyclopedia application, a newspaper application, etc. The applications may provide output that includes content (e.g., content 102A, 102B, or 102C) and a control region that includes control buttons (e.g., regions 104B, and 104C that include user interface icons 106B, 108B, 110B, 112B, 106C, 108C, 110C or 112C).

The touch screen driver 210 is configured to receive input (e.g., touch input entered via an input object) from a touch screen and to provide output (e.g., visual data, for example content 102A, 102B, or 102C or regions 104B or 104C) for display via the touch screen. The subject technology is illustrated in FIGS. 1A-1C and FIG. 2 in conjunction with a touch screen. However, in some aspects, the touch screen may be replaced with a mouse and a non-touch display, a display coupled with arrows on a keypad for moving within the display, a display coupled with a microphone for providing voice commands for navigating within the display, or any other input/output system that can provide scrollable visual output. In these aspects, the touch screen driver 210 may be replaced with driver(s) for other input/output device(s).

The user interface management module 212 is configured to manage the user interface of the computing device 200. The user interface management module 212 is configured to detect a first scroll (e.g., scroll via arrow 114B) beyond an original content (e.g., content 102A) being presented for a user. The first scroll indicates an overscroll event. As used herein, the phrase “overscroll event” refers to a scroll event that causes scrolling beyond a termination point content displayed in an application. For example, a scroll event that causes scrolling above the word “San Francisco” in content 102A of mobile device 100A. The user interface management module provides for display of menu content (e.g., region 104B or 104C) upon detection of the first scroll. The menu content includes one or more actionable items (e.g., user interface icons 106B, 108B, 110B, 112B, 106C, 108C, 110C or 112C). The menu content may be fully displayed (e.g., region 104C) or partially displayed (e.g., region 104B). The actionable items may be static or may dynamically change based on the original content being presented for the user or the direction of scrolling. The actionable items may include the most frequently accessed actionable items by the user or by a set of users in an application. However, the user may opt-out of having any application store actionable items that he/she most frequently accesses or the user provides affirmative permission for the application to store this information. Actionable items may be retrieved from settings or configurations for menus stored over the network. In some cases the settings/configurations for menu items may correspond to an individual user's profile.

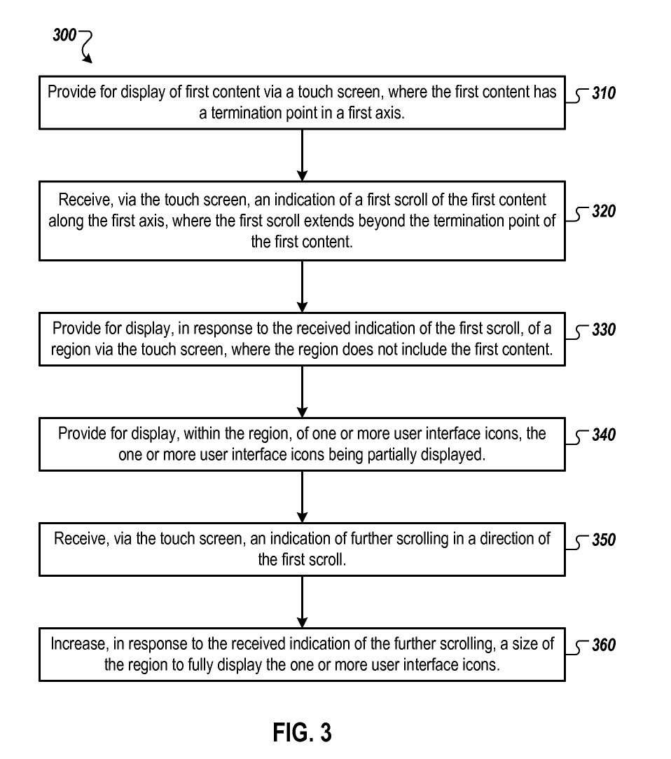

FIG. 3 illustrates an example process 300 for displaying user interface icons in response to scrolling.

The process 300 begins at step 310, where a computing device (e.g., computing device 200) provides for display of first content (e.g., content 102A) via a touch screen. The first content has a termination point in a first axis (e.g., as shown in FIG. 1A, the content 100A has a termination point in the vertical axis above the word “San Francisco”).

At step 320, the computing device receives, via the touch screen, an indication of a first scroll of the first content along the first axis (e.g., a downward scroll as indicated by arrow 114B). The first scroll extends beyond the termination point in the first axis (e.g., the first scroll causes the content 102B to scroll further downward than the word “San Francisco,” revealing region 104B).

At step 330, the computing device provides for display, in response to the received indication of the first scroll, of a region (e.g., region 104B) via the touch screen. The region does not include the first content. The region may not be displayed before the indication of the first scroll is received. For example, as illustrated in FIGS. 1A and 1B, the region 104B of FIG. 1B is not displayed in the interface 100A of FIG. 1A, which is presented before the scroll indicated by arrow 114B is received.

At step 340, the computing device provides for display, within the region, of one or more user interface icons (e.g., user interface icons 106B, 108B, 110B, or 112B). The one or more user interface icons are partially displayed (as shown in FIG. 1B). In some aspects, the one or more user interface icons are for entering command(s). The command(s) could be associated with an application that displays the first content or the commands could be independent of the application. For example, if the application is a newspaper application, the command(s) may include a home command, a previous article command, a next article command, or a get latest news command. If the application is a web browser, the command(s) may include a new tab command, a close tab command, a back command, or a forward command. If the application is an electronic messaging (e.g., email) application, the commands may include a next message command, a previous message command, a compose new message command, or a delete message command.

At step 350, the computing device receives, via the touch screen, an indication of further scrolling (e.g., scrolling as indicated by arrow 114C) in a direction of the first scroll (e.g., the downward direction, as indicated by arrow 114B).

At step 360, the computing device increases, in response to the received indication of the further scrolling, a size of the region to fully display the one or more user interface icons (e.g., as illustrated in FIG. 1C, the size of the region 104C is increased with respect to the region 104B, and the user interface icons 106C, 108C, 110C, or 112C are fully displayed; these fully displayed user interface icons 106C, 108C, 110C, or 112C correspond to the partially displayed user interface icons 106B, 108B, 110B, or 112B of FIG. 1B). After step 360, the process 300 ends.

The process 300 is described in conjunction with a touch screen that is scrolled by touching. However, the subject technology may be implemented in conjunction with other input/output devices. For example, the touch screen that is scrolled by touching may be replaced by a display (e.g., a non-touch display) that is scrolled via a mouse, a joystick, a keypad, or voice commands.

As shown in FIG. 3 and described above the steps 310-360 of the process 300 are implemented in numerical order and in series. However, the steps 310-360 may be implemented in any order. In some aspects, two or more of the steps 310-360 are implemented in parallel.

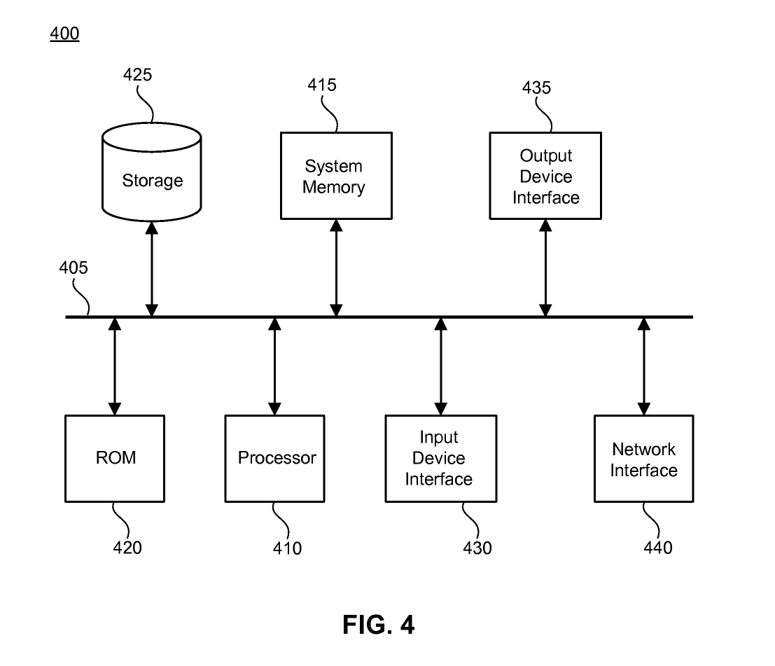

FIG. 4 conceptually illustrates an electronic system 400 with which some implementations of the subject technology are implemented. For example, the computing device 200 may be implemented using the arrangement of the electronic system 400. The electronic system 400 can be a computer (e.g., a mobile phone, PDA), or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the processes of the subject technology are stored in the system memory 415, the permanent storage device 425, or the read-only memory 420. For example, the various memory units include instructions for displaying actionable items in an overscroll area in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touchscreen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (“LAN”), a wide area network (“WAN”), or an Intranet, or a network of networks, for example the Internet. Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method for user interface management, the method comprising:
detecting a first scroll beyond an original content being presented for a user, wherein the first scroll indicates an overscroll event;
providing for display of menu content upon detection of the first scroll, wherein the menu content includes one or more actionable items, wherein the one or more actionable items in the menu content dynamically change based on the original content being presented for the user.

2. The method of claim 1, further comprising:
detecting a second scroll beyond the original content, wherein the second scroll indicates scrolling beyond the original content that does not amount to an overscroll event; and
providing for partial display of the menu content upon detection of the second scroll.

3. The method of claim 1, wherein the first scroll is in an upwards direction and the menu content provided for display is on a bottom portion of the original content.

4. (canceled)

5. The method of claim 1, further comprising:
detecting a third scroll in a direction opposite the first and second scrolls; and
providing, in response to the third scroll, for removing display of the menu content, wherein the resulting display includes the original content being presented for the user.

6. The method of claim 1, further comprising:
receiving a selection of one of the one or more actionable items.

7. The method of claim 6, wherein receiving the selection of the one or more actionable items comprises:
receiving an indication of a touch at a position corresponding to the one or more actionable items.

8. The method of claim 7, wherein the first scroll is associated with a first input object, wherein the first input object is held in an end position of the first scroll during the touch at the position corresponding to the one or more actionable items, and wherein the touch at the position corresponding to the one or more actionable items is associated with a second input object different from the first input object.

9. The method of claim 6, wherein the selection of the one or more actionable items further comprises:
detecting an additional scroll, wherein the additional scroll corresponds to a request to continue displaying the menu items upon release of the additional scroll.

10. The method of claim 9, wherein the additional scroll forms an angle with the first scroll.

11. The method of claim 1, wherein the first scroll is associated with a first input object, the method further comprising:
receiving an indication of release of the first input object from a touch screen, wherein the original content is presented on the touch screen.

12. The method of claim 11, further comprising:
continuing providing for display of the menu content upon the release of the first input object from the touch screen.

13. The method of claim 11, further comprising:
providing for removal of the menu content upon the release of the first input object from the touch screen.

14. A non-transitory computer-readable medium for user interface management, the computer-readable medium comprising instructions which, when executed by a computing device, cause the computing device to implement a method, the method comprising:
providing for display of first content via a touch screen, wherein the first content has a termination point in a first axis;
receiving, via the touch screen, an indication of a first scroll of the first content along the first axis, wherein the first scroll extends beyond the termination point of the first content;
providing for display, in response to the received indication of the first scroll, of a region via the touch screen, wherein the region does not include the first content;
providing for display, within the region, of one or more user interface icons for entering commands, wherein the one or more user interface icons dynamically change based on the first content being presented for display.

15. The computer-readable medium of claim 14, wherein the region is not provided for display before the indication of the first scroll is received.

16. The computer-readable medium of claim 14, wherein the first content is associated with an application, and wherein the one or more user interface icons are for entering commands within the application.

17. The computer-readable medium of claim 16, wherein the application comprises a web browser, and wherein the commands within the application comprise one or more of a new tab command, a close tab command, a back command, and a forward command.

18. The computer-readable medium of claim 16, wherein the application comprises an electronic messaging application, and wherein the commands within the application comprise one or more of a next message command, a previous message command, a compose new message command, or a delete message command.

19. The computer-readable medium of claim 14, wherein at least one of the one or more user interface icons in the region is partially displayed.

20. A system for user interface management, the system comprising:
one or more hardware processors; and
a memory comprising instructions which, when executed by the one or more processors, cause the one or more hardware processors to implement a method, the method comprising:
providing for display of first content via a touch screen, wherein the first content has a termination point in a first axis;
receiving, via the touch screen, an indication of a first scroll of the first content along the first axis, wherein the first scroll extends beyond the termination point of the first content;
providing for display, in response to the received indication of the first scroll, of a region via the touch screen, wherein the region does not include the first content;
providing for display, within the region, of one or more user interface icons, the one or more user interface icons being partially displayed;
receiving, via the touch screen, an indication of further scrolling in a direction of the first scroll; and
increasing, in response to the received indication of the further scrolling, a size of the region to fully display the one or more user interface icons, wherein the one or more user interface icons dynamically change based on the first content being presented for the user.
